(19) United States
(12) Patent Application Publication
(10) Pub. No.: US 2007/0218170 A1
(43) Pub. Date: Sep. 20, 2007

(54) Fiber Containing Alkaline Beverage and Methods For Production Thereof

(75) Inventor: Ronald Kendrick, Coquitlam (CA)

Correspondence Address: SWANSON & BRATSCHUN, L.L.C., 8210 SOUTHPARK TERRACE, LITTLETON, CO, 80120, US

(73) Assignee: HEALTH BEVERAGE LLC, Coquitlam (CA)

(21) Appl. No.: 11/681,226

(22) Filed: Mar. 2, 2007

Related U.S. Application Data
(60) Provisional application No. 60/779,021, filed on Mar. 3, 2006.

(51) Int. Cl. A23L 1/30

(52) U.S. Cl. 426/74; 426/590

(57) ABSTRACT

The present invention provides alkaline soluble fiber compositions and methods for preparing the same. Soluble fiber for use in the compositions of the invention is contributed from one or more sources and is preferably inulin, FOS and/or scFOS. In some cases the compositions have a pH of between 8.0 and 9.5.

### RELATED APPLICATIONS

This application claims priority under 35 U.S.C. 119(e) to U.S. Provisional Patent Application No. 60/779,021 entitled “FIBER CONTAINING ALKALINE BEVERAGE AND METHODS FOR PRODUCTION THEREOF” filed Mar. 3, 2006, the disclosure of which is hereby incorporated by reference in its entirety.

### BACKGROUND OF THE INVENTION

a. Field of the Invention

The invention generally relates to alkaline beverages and more particularly to soluble fiber containing alkaline beverages and methods of producing the same.

b. Background Art

Dietary intake of soluble fiber has been shown to provide several health benefits including lowering blood cholesterol and moderating blood glucose levels. These benefits are believed to limit the risks associated with heart disease and to some extent, the risks of developing type 2 diabetes. Other benefits to dietary soluble fiber include at least promoting immune function, assisting in weight management and reducing the risks of developing certain gastrointestinal based cancers.

The American diet is notoriously deficient in dietary fiber. Fiber, especially soluble fiber, is found in fruits and vegetables such as oats, beans, legumes, barley, citrus fruits and vegetable gum. However, due to preparation practices, availability, and to the foods themselves, i.e., taste, it has proven difficult for most people to get the Federal Drug Administration (FDA) recommended levels of soluble fiber in their diet.

As an alternative, soluble fiber can be introduced into a diet via a beverage composition. However, the vast majority of liquid beverages on the market do not contain fiber, rather these liquid beverages are focused on taste. For example, most conventional beverage drinks have little or no fiber, are at an acidic pH (below 4) and contain flavoring and sweeteners to enhance taste, i.e., fruit drinks, carbonated soda, various sports drinks, etc. These beverages benefit from strong consumer acceptance, and the high acidity allows for reduced need for protection with regard to bioagent control. Unfortunately, they also provide little benefit with regard to fiber intake.

Dietary (soluble and insoluble) fiber containing beverages like Metamucil® (Procter and Gamble) are commercially marketed as a dietary fiber supplement, but these products tend to form a gritty beverage, typically consumed only when necessitated by symptoms that require stool softening or as related to lowering the risk of heart disease. This line of products is typically acidic to neutral in nature, and their organoleptic properties have limited consumer acceptance. In addition, soluble fibers such as Benefiber are now also available in powdered form and can be added to water or other beverages. However they offer no additional nutritive value, offer no flavor and are also typically added to acidic beverages.

Little research has been directed toward the development of non-acidic or alkaline based beverages, as these beverages have not proven to have wide consumer acceptance, especially with regard to organoleptic properties. In addition, alkaline based beverages pose both spoilage and bioagent related concerns, concerns which generally don't apply to acidic based beverages. However, alkaline based beverages have been known to provide various health benefits, including antioxidant properties (Biochem. Biophys. Res. Commun., 234, p 269-274 (1997). Recently, U.S. Pat. No. 6,572,902 to Abramowitz et al describes a process for producing consumable alkaline water having a TDS range of 22-240 parts per million (ppm). However, the water was limited to incorporation of various vitamins (no fiber), including ascorbic acid which could reduce the pH of the water in the absence of any buffering system.

As such, there is a need in the art to prepare a beverage that combines the health benefits of soluble fiber with the health benefits of an alkaline solution in a way that overcomes concerns over spoilage, bioagents and organoleptic properties.

Against this backdrop the present invention has been developed.

### BRIEF SUMMARY OF THE INVENTION

The invention solves the above problems, as well as other problems of the prior art, by providing fiber containing alkaline compositions. In one embodiment, the invention provides alkaline compositions that include one or more soluble fibers. The pH of the alkaline compositions is typically above 7.5 and more typically between 8.0 and 9.5 and can be between about 9 and 9.5.

In one preferred embodiment, the invention provides alkaline beverages that include a soluble fiber from the group of inulin, fructooligosaccharides and short chain fructooligosaccharides; most preferably the composition also includes a second type of soluble fiber, e.g., arabinogalactan and/or partially hydrolyzed guar gum. The combined soluble fibers providing a blended soluble fiber ingredient to the alkaline composition.

In another preferred embodiment, the invention provides alkaline compositions having one or more soluble fiber constituents and one or more other ingredient. In preferred embodiments the additional ingredient is a probiotic.

In another preferred embodiment, the invention provides methods for preparing shelf-stable alkaline compositions.

These and various other features and advantages of the invention will be apparent from a reading of the following detailed description and a review of the appended claims.

### DETAILED DESCRIPTION OF THE INVENTION

The following description is directed at consumable beverages having an alkaline based aqueous medium that includes a useful amount of soluble fiber. Embodiments of the invention can include herbs, botanicals, flavoring agents (including sweeteners), nutrients, and various probiotics. The compositions of the invention generally maintain alkalinity and generally incorporate ingredient profiles that leave the compositions in an alkaline pH range. Note, however, embodiments of the invention can also include buffering reagents to limit pH flux and maintain the beverage pH within the alkaline range. Compositions of the present invention provide a healthy, highly soluble fiber intake beverage with a favorable taste profile, i.e., organoleptic.

Beverage Compositions of the Invention

Embodiments of the present invention include consumable alkaline based beverages having a high content of soluble fiber. Beverages of the invention are developed to be both healthy, providing benefits for high soluble fiber content and for alkalinity, as well as for an agreeable taste profile.

Compositions of the present invention have an aqueous medium base, i.e., water or any liquid made with water as a constituent. The aqueous medium base is alkaline. For purposes of the present invention the term “alkaline” or “alkalinity” refers to aqueous medium having a pH of between 7.1 and 14. As such, alkaline aqueous medium compositions of the present invention will have a pH that exceeds 7.1. However, and more typically, the aqueous medium composition embodiments of the present invention will have a pH of between about 7.5 and a pH of about 10.0. In certain embodiments of the invention, the pH of the composition is between about 8.0 and about 9.5, and in some instances between about 9.0 and about 9.5. The alkaline pH ranges of the present invention provide health benefits to the user. A user or consumer of the composition(s) of the present invention should stay well hydrated and slightly more alkaline than acidic. For example, a user that hydrates with alkaline compositions would likely be less likely to suffer joint pain, bone loss, headaches and lack of energy.

In preferred embodiments of the invention the aqueous medium is alkaline water. Alkaline water for purposes of the invention can be obtained by adding an appropriate amount of potassium hydroxide, sodium hydroxide or other like base with potable water to provide water with a target pH (for example as described in U.S. Pat. No. 5,306,511, which is herein incorporated by reference in its entirety). Alternatively, alkaline water of the invention can be prepared via the methods described in U.S. Pat. No. 6,572,902 ('902), which is incorporated herein by reference in is entirety. Briefly, the methods of the '902 patent include filtering, purifying and then electrolyzing mineralized water to produce alkaline water. Other methods for preparing alkaline based water or aqueous medium are contemplated to be within the scope of the present invention as long as the product is ultimately potable and has an alkaline pH.

Dietary fibers of many types are often categorized by their solubility characteristics in the human digestive system and have different chemical characteristics related to their chemical structure and may have varying degrees of physiological effects on the human body. The solution will contain a fiber source or most likely a fiber blend that is chosen with a particular combination of physiological effect, flavor & sensory profile, caloric content and container/package in mind.

The physical and chemical properties of the fiber will naturally affect its final function within a beverage system including: caloric contribution, viscosity, mouthfeel, stabilization, suspension, flavor, pH and temperature stability, colour and solubility including the impact of the sensory profile. Additionally fiber selection will be guided by the aptitudes of specific fibers concerning the desired physiological benefits (for the end or the particular need or the need for a consumer to avoid or minimize the undesirable properties) associated with a particular fiber. Further, the consumer's preference or lack thereof for “natural” ingredients and organoleptic properties will have a definite bearing on the fiber(s) chosen. Hence, when choosing a fiber sources(s) for specific beverage types, physiological effects and physical and chemical function must be considered together, in order to achieve the desired product.

Some fibers have a greater impact on viscosity, mouthfeel and/or the ability to “carry” flavoring, and/or inherent sweetness and/or color contribution. High use levels of these ingredients may or may not be organoleptically acceptable and therefore the desirability or undesirability of these attributes will dictate the use or level of use in any particular solution. Additionally technological aspects of certain production processes will have a bearing on the selection and use or level of use of certain fibers. As will the technological performance of the fiber in alkaline solution in varying storage conditions particularly as it relates to temperature and temperature cycling, light exposure and relative humidity over time.

Additionally and of at least equal importance is the physiological response to certain fibers or combination of certain fibers in efficacious dosage. It will be important that dosages of certain fibers alone or in combination do not lead to undesirable physiological responses such as flatulence, diarrhea and other forms of gastric upset. All fibers that are excreted partially or totally unfermented can lead to Taxation, while fibers that are fermented can lead to flatulence. Regardless, significant gastric upset can be commensurate with dosage. In the case of Fructans for example the longer the chain the longer the fermentation profile and the longer the fermentation profile the more flatulence that can develop. The rapid and complete fermentation of fast fermenting prebiotics with subsequent gas production and accumulation of lactic acid can cause gastric discomfort and gastrointestinal stress. This is particularly true for total dietary fiber levels at 5 g (or more) per serving. While there are benefits to both fibers, care must be taken to avoid undesirable physiological dose responses.

Additionally, carbohydrate based polymers are subject to hydrolysis under certain conditions. Hydrolysis may affect the shelf life of beverages in terms of organoleptic quality and also functionality. Hydrolysis rate depends on many factors including: type of bonds present, size and shape of the polymer, pH, water activity, temperature and time. The size and various possible side chains of these polymers affect their physical and physiological performance. For example, fructans including inulin, oligofructose and scFOS are unstable in acidic conditions. They begin to hydrolyze, and refrigerated storage is required to preserve integrity. Acidic conditions below 4.5 can break the fructans into residual sugars and the sugar into monosaccharides. Should this occur, this would result in increased regulatory risk, as the label would not be fully reflective of true nutrient content of the food, both in terms of total dietary fiber and in terms of sugar content. The product would become sweeter with more calories and conceivably putting diabetics at risk while losing other health benefits associated with dietary fiber. Fibers that are hydrolyzed due to acidic conditions will be protected from this by an alkaline solution.

Some fibers have better performance in some areas than others. For example studies show that oligofructose may not reduce the glycemic response and/or reduce the blood glucose response as much as other fibers, but may provide better organoleptic benefits. Research shows that the prebiotic benefit varies quite significantly among soluble fibers and studies have shown scFOS to be one of the most effective prebiotic soluble fibers. However the fructan group does present some risk concerning gastric disturbance.

Studies have shown that partially hydrolyzed guar gum can offer better performance associated with diarrhea and relieving irritable bowel syndrome but as a stand alone fiber may suffer from organoleptic problems for some users.

As another example studies show that arabinogalactan may provide better immune enhancing benefits but its flavor may preclude it from being used solely in higher dosages in water and difficult to mask in a water solution.

Resistant maltodextrin may be an excellent choice for both glucose response and cardiovascular benefit but discoloration at higher dosages might be undesirable.

It can be seen from the above that different fibers possess different qualities and concerns related to physiological benefit, processing options, sensory performance, caloric content and the like. Therefore, a blend of fibers will be appropriate in conjunction with specific nutrient additives for solutions particular of particular benefits. For reasons related to physiological benefit, organoleptic impact, cost, caloric content, container selection, shelf life, availability, process compatibility and natural status etc. a fiber blend in an alkaline solution can always be appropriate. The following illustrates some potential solutions using various fibers (arabinogalactan, gum acacia, inulin, oligofructose, partially hydrolyzed guar gum, polydextrose, resistant maltodextrin and scFOS) for consideration when establishing a fiber blend for a particular application in alkaline (reduced) water.

Soluble Fiber:

The alkaline aqueous medium of the present invention include a useful amount of water-soluble, i.e., “soluble,” fiber. Soluble fiber is comprised of components from plant materials (or analogous carbohydrates) that resist digestion in the small intestine.

Some of the more beneficial sources of fiber are from the family of fructooligosaccharides (FOS) and include inulin, oligofructose and short-chain (sc) FOS, all of which are sensitive to hydrolization of pH's of below 5 and are best preserved in neutral to alkaline conditions (in the pH range of the invention).

Soluble fiber intake is associated with the fiber acting like a prebiotic, i.e., a material that creates an optimal environment for healthy intestinal flora. Prebiotics are typically non-digestible ingredients that selectively stimulate the growth and activity of “beneficial” bacteria, i.e., probiotics, within the intestine (especially scFOS). In addition, soluble fiber is fermented in the large intestine where it is broken down into short chain fatty acids which are believed to have the additional benefit of protecting against diarrhea, intestinal inflammation, colon cancer and supporting the immune system.

In addition to the prebiotic function of the soluble fiber, soluble fiber may also be included in alkaline aqueous medium of the invention to act as a sweetening agent. Typical soluble fibers that provide this dual function include fibers having some amount of sugars like FOSs, or other like fibers. Further, it has been shown that soluble fiber enhances the uptake of calcium and other like nutritional materials into the consumer. As such, use of FOSs can provide a combination of benefits including prebiotic function, sweetening agent and calcium update ingredient.

As previously noted, soluble fiber sources include oats, wheat, beans, soy, legumes, barley, corn, larch trees, various roots, citrus fruits and vegetable gum. Typical fiber types obtained from these sources include: pectin, guar gum, beta-glucan, inulin, acacia gum, maltodextin (FiberSol2™), arabinogalactin, soluble soy fiber, soluble oat fiber, soluble psyllium fiber, cellulose gum and other like fibrous materials.

Preferred soluble fiber for embodiments of the invention includes inulin, oligofructose, and scFOS. Inulin is found in more than 36,000 plants and is present in significant quantities in vegetables such as artichokes, asparagus, leeks, onions, garlic and wheat. Inulin is found in particularly high levels in chicory roots. Another preferred soluble fiber constituent for the invention is fructooligosaccharides (FOS), a natural constituent of inulin. FOS is obtained from inulin through a partial enzymatic hydrolysis. FOS is fermented by many probiotic strains of bacteria, e.g., Bifidobacterium, and tends to do so at the expense of pathogenic bacteria in the intestine. In addition, inulin and/or FOS have been shown to provide a significant increase in the adsorption of calcium in the body and may even improve bone mineral density.

Another preferred soluble fiber for inclusion in an embodiment of the invention is acacia fiber or gum arabic, obtained from the gum of the acacia tree. Acacia fiber is a prebiotic that also has been shown to slow down colonic fermentation, thereby decreasing gas production and bloating within the intestine. Acacia fiber is a dried gummy exudation obtained from the stems and branches of the acacia Senegal. The underground product occurs as white or yellow-white spheroidal tears of varying size and angular fragments.

In structure, gum Arabic is a complex and variable mixture of arabinogalactan oligosaccharides, polysaccharides and glycoproteins. The fiber mainly contains high molecular weight polysaccharides and their calcium, magnesium and potassium salts. The fiber is pH tolerant, especially at the alkaline pH range of the present invention.

The physiological effects of gum arabic include fecal weight increase, retarding glucose adsorption, production of short chain fatty acids in the colon (beneficial to probiotic bacteria propagation), simulation of beneficial bacteria and decreasing serum cholesterol. The fiber is water soluble and does not ferment in the colon.

Another preferred soluble fiber for inclusion in an embodiment of the invention is guar gum (partially hydrolyzed). Guar gum is sourced from the seeds of the guar plant and is considered natural by U.S. and Canadian regulators as well as natural food retailers. The fiber provides low viscosity and maintains physiological effects associated with dietary fibers. It has also been shown that guar gum enhances the absorption of nutrients and is more effective than other fibers in moderating diarrhea and providing benefit against irritable bowel syndrome.

Another preferred soluble fiber for inclusion in embodiments of the invention is soy fiber. Soy is an excellent source of fiber (˜15% by weight), containing both soluble and insoluble fiber. Studies have shown that soy fiber acts as a prebiotic and provides a benefit in lowering LDL cholesterol and triglycerides.

Another preferred soluble fiber for inclusion in embodiments of the invention is arabinogalactan. Arabinogalactan is a low-viscosity polysaccharide gum, approved by the FDA as a source of dietary fiber. Arabinogalactan has been shown to be an immune-stimulating agent and an anticancer aid. Arabinogalactans are long, densely branched polysaccharide water soluble polysaccharides found in plants, fungi and bacteria. Normal dietary intake comes from foods such as carrots, radishes, tomatoes, pears and wheat. Larch arabinogalactan is naturally occurring dietary fiber extracted from native Larch trees and is commercially available. Arabinogalactan behaves like a dietary fiber when ingested, reaching the large intestine intact.

Arabinogalactan supports gastrointestinal health and enhances colon health by acting as a food source for beneficial bacteria in the gut (e.g., Bifidobacteria and/or Lactobacilli). Since the arabinogalactan ferments slowly, it provides some benefit with reduced side effects such as gas and bloating, as often associated with other fiber choices. The fiber also supports cardiovascular health studies.

Another preferred soluble fiber for inclusion in embodiments of the invention is glucose polymer (see for example Litesse®, Danisco) (polydextrose). Glucose, sorbitol and food acid are used for the manufacture of glucose polymer which is stable in solution at low pH and high temperatures, especially compared to linear polymers like fructooligosaccharides. The polymer forms clear, colorless solution with high solubility.

Evidence demonstrates that glucose polymer provides the physiological benefits of soluble dietary fiber. Since the polymer is fermented slowly it provides a sustained release of energy in the colon, causing a shift in the microbial community in the gut and allows the further fermentation of harmful lactic acid. Gas and lactic acid production are minimized. The fiber is particularly useful in the compositions of the invention as it is clear and has little viscosity (also having minimal taste impact).

In a preferred embodiment of the invention, the soluble fiber content of the alkaline beverage is contributed from inulin, FOS, scFOS or combinations of the same. Inulin, scFOS and FOS (and especially oligofructose) offer sweet, pleasant flavors. Each is highly soluble with a flavor that enhances the sensory properties of recipient beverage compositions. One physiological effect of these fibers is that their actions stimulate Bifidobacteria growth in the intestine. Nourishing beneficial bacteria, such as Bifidobacteria, with these fibers allows them to compete out potential detrimental organisms in the host. Health benefits ascribed to Bifidobacteria include inhibiting the growth of harmful bacteria, stimulating components of the immune system and aiding the adsorption of certain ions and the synthesis of B vitamins. Inulin and oligofructose have been termed “prebiotics” because they are nondigestible food ingredients that selectively stimulate growth and/or activity of a number of potentially health-stimulating intestinal bacteria. The differences in chain length between inulin, oligofructose and scFOS account for their different functional attributes.

Due to longer chain length (DP up to 60), inulin is less soluble than oligofructose and can form microcrystals when sheared in water or milk. These crystals are not discretely perceptible in the mouth, but they interact to form a smooth creamy texture and may be useful sensory performers in some solutions.

Oligofructose is composed of shorter-chain oligomers (DP up to 10) and possesses functional qualities similar to sugar or glucose syrup. Oligofructose is more soluble than sucrose and provides about 30-50% of the sweetness of table sugar. Oligofructose can act in much the same manner as sugar, but with the added benefit of fewer calories, fiber enrichment and other nutritional properties.

scFOS is a variation of FOS. A large part of the difference is associated with chain length, with inulin being the longest and scFOS being the shortest and the amount of fructose terminated molecules rather than glucose terminated molecules. Inulin is a polysaccharide that contains a small percentage of FOS. Oligofructose is about 45% FOS but 55% fructose terminated molecules which can be used by any bacteria, good or bad, as a food source. scFOS is 95% short chain and with glucose terminated molecules that only feed the good bacteria.

In embodiments of the invention, soluble fibers of the invention are combined with probiotics to promote the consumer's health. The combinations of pre- and pro-biotics have synergistic effects, referred to herein as symbiotic, because in addition to the action of prebiotics that promote the growth of existing strains of beneficial bacteria in the colon; inulin and oligofructose also act to improve the survival, implantation and growth of newly added probiotic strains of bacteria.

In addition to calorie and fat reduction, fiber effects, lipid modulation and bifidus stimulation, the results of studies have also indicated that inulin and oligofructose can have positive effects on calcium adsorption

Presently, the average intake of dietary fiber in the United States is approximately 10 grams/day. Recommendations from various health related sources state that this amount of fiber should be increased to approximately 25-30 grams of dietary fiber/day (United States Food and Drug Administration specifies 25 gram/day for the Daily Reference Value) (Garrison and Somer, 1995). In fact, the United States Food and Drug Administration labels foods that include 2.5 grams of dietary fiber as being a “good source” of fiber.

Embodiments of the present invention include from 0 grams to 60 grams of soluble fiber per liter of alkaline based aqueous medium. More preferably, the alkaline aqueous medium of the invention have from about 2.5 grams soluble fiber to about 25 grams soluble fiber per liter, and in most preferred embodiments the alkaline based aqueous medium have from about 5 to about 25 grams soluble fiber per liter. As noted above, the soluble fiber content can come from one or more fiber sources, for example 5 g scFOS and 10 g inulin.

Note that some embodiments of the present invention can also include some amount of insoluble fiber.

Typical embodiments of the present invention are alkaline based and include one or more sources of soluble fiber. These compositions can include one or more of the following ingredients, in addition to soluble fiber, to provide a healthy beverage having a satisfying taste profile.

Soluble Fiber Blends:

Various combinations of different soluble fibers can be included in embodiments of the present invention. Compositions of the invention include a total amount of soluble fiber, as described above, that's provided by two or more different types of soluble fiber.

Typically, combinations of different soluble fibers are included in beverage compositions of the invention to enhance physiologic benefits of each included fiber, to enhance a targeted use for the composition, for example, provide an enhanced benefit to a user's bone health, or to provide symbiotic compositions where each fiber additive enhances the effect of either the other fiber(s) benefits or other additives within the composition.

In a preferred embodiment, inulin, FOS and/or scFOS is combined with one or more soluble fibers. The inulin, FOS or scFOS provide both extensive health benefits as described above, but also act as a sweetener to mask or modify the taste of the other soluble fiber ingredients. This particular use of these sweetener fibers can only fully be accomplished in an alkaline solution (in accordance with the invention) as inulin, FOS and scFOS are unstable in acidic solutions. Also note that combinations of inulin, FOS and scFOS with other fibers reduce some of the gastric distress that can accompany use of these fibers alone.

For example, an alkaline aqueous medium can include both inulin and arabinogalactan.

Other Ingredients:

In addition to soluble fiber, embodiments of the present invention can optionally include herbs, botanicals, natural and synthetic flavoring agents, nutrients, sweeteners, synthetically prepared colors, natural colors, preservatives, herbs or forms thereof, proteins, amino acids, dietary enzymes, black cohosh, L-arginine, colostrums, ribose, lutein, CₒQ₁₀, probiotics, and the like.

Nutrients:

Nutrients for inclusion in compositions of the invention include various minerals and vitamins. Minerals of the invention can include, but are not limited to: calcium, phosphorus, magnesium, iron, zinc, chromium, iodine, selenium, copper, potassium, and fluoride.

In one preferred embodiment, calcium is added to the soluble fiber containing alkaline beverages of the present invention. Calcium is the most abundant mineral in the body with about 99% of the calcium found in the bones. Calcium is an alkalizing agent and helps build healthy bones and teeth. Calcium also provides a benefit in various enzymatic reactions in the body, for example, being required for muscle contraction, release of neurotransmitters, regulation of heartbeat, and normal clot formation of the blood. Supplementation of the beverage compositions of the present invention can also be used to limit the effects of osteoporosis.

In another preferred embodiment, magnesium is added to the soluble fiber containing alkaline beverages of the present invention. Magnesium is known for its calming effect on the nervous system (necessary for normal nerve and muscle impulse), as well as stimulating the immune system. Magnesium has also been shown to facilitate calcium and potassium uptake.

In another preferred embodiment, potassium is added to the soluble fiber containing alkaline beverage of the present invention. Potassium is critical in maintaining proper electrolyte and acid balance in the body and well as being involved in numerous cellular exchanges. Potassium has been shown to reduce the risk of high blood pressure and stroke as well as soothe feelings of anxiety, irritability and stress.

In another preferred embodiment, iron is added to the soluble fiber containing alkaline beverages of the present invention. Iron is required in the diet for normal formation of hemoglobin and myoglobin. In addition, iron is required by various enzymes, i.e., cytochromes, in the body critical for metabolism. Cytochromes are required for the metabolism and detoxification of many natural compounds in the body as well as chemicals, drugs and environmental pollutants. Note also that iron has been shown to strengthen the immune system and improve learning ability and exercise performance.

In another preferred embodiment, phosphorous is added to the soluble fiber containing alkaline beverages of the present invention. Phosphorous is a nonmetallic element essential to metabolize protein, calcium, and glucose. Phosphorous is required for bone, connective tissue and tooth formation, for cell growth, for hearth muscle contraction, and for kidney filtration. Phosphorous also helps the body utilize vitamins, assists other body functions to convert food into energy, and maintains the blood's pH.

In another preferred embodiment, selenium is added to the soluble fiber containing alkaline beverages of the present invention. Selenium is involved as a cofactor for the antioxidant enzyme glutathione peroxidase. Selenium is required for a healthy immune system and protects the body from heavy metal contamination. Selenium is also involved in reducing the risk of developing certain types of cancer, of developing liver disorders, heart conditions, and reducing the risk of birth defects during pregnancy.

In another preferred embodiment, zinc is added to the soluble fiber containing alkaline beverages of the present invention. Zinc has been shown to play a role in numerous enzyme reactions and is essential for normal growth and development. Zinc is also involved in providing a healthy immune system and in normal wound healing.

In another preferred embodiment, copper is added to the soluble containing alkaline beverages of the present invention. Copper has been shown to play a role in the normal function of various enzymes. Copper is involved in transfer of iron from storage areas in the body to make red blood cells. Further, copper is important in the formation of bones and connective tissue.

In another preferred embodiment, chromium is added to the soluble containing alkaline beverages of the present invention. Chromium is an important component of glucose tolerance factor, a substance that works with insulin to bring blood sugar into the cells of the body. Chromium has also been shown to be involved in carbohydrate, fat, and protein digestion. The body's ability to adsorb chromium appears to decrease with age and chromium deficiency is associated with poor glucose tolerance.

The amounts of mineral to include in the compositions of the invention are of nutritionally relevant amounts, although an amount of between 1% to 100% of the Recommended Daily Intake is preferred. Compositions of the invention can include at least one mineral or a mixture of minerals. Note that the soluble fiber in the alkaline compositions of the invention provide an excellent conduit for enhancing the uptake of the mineral into the consumer.

Vitamins for inclusion in compositions of the invention include, but are not limited to, vitamins K, D, E, A, B₆, B₁₂, biotin, riboflavin, and niacin. Note that for purposes of the present invention the term “vitamin” also includes the vitamin precursors, derivatives and isoforms, e.g., cholecalciferol, L-isoascorbic acid, etc. Vitamins are included in nutritionally relevant amounts, although an amount of between 1% and 100% of the Recommended Daily Intake is preferred. Compositions of the invention can include at least one vitamin or a mixture of vitamins. As was the case for mineral adsorption in a consumer, the soluble fiber in the compositions of the present invention provide an excellent conduit for enhancing the uptake of the vitamins into the consumer.

Note that where the vitamin is acidic, the non-acidic form of the vitamin is preferred (due to the pH conditions of the compositions of the present invention). For example, vitamin C is preferably added to the compositions of the invention as calcium ascorbate or citrus bioflavonoids. Note also that vitamins can be included in embodiments of the present invention to enhance the compositions beverage platform: for example, vitamin D can be combined with calcium in a beverage that is marketed as a calcium supplement beverage.

Sweeteners:

Sweeteners of the invention include agents that naturally or artificially enhanced the sweetness of the compositions to comply with certain sweeter taste profiles. Embodiments of the invention include addition of one or more of sucralose, saccharin, aspartame, synthetic alkoxy aromatics, L-aspartyl-hydroxymethyl alkane, cyclamates, acesulfame potassium, fructose, sucrose, sugar alcohols, other natural sweeteners, and the like. The amount of sweetener added to the compositions of the invention is typically determined by consumer taste, with different compositions including differing amounts of sweetener dependent on the target market. Note the discussions throughout on the sweetener aspect of FOSs and scFOS.

Coloring Agents:

Coloring agents to enhance the aesthetic properties of the compositions of the present invention can also be included in embodiments of the present invention. Any coloring agent that is soluble and approved for use in beverages can be utilized in the present invention.

Preservatives and Probiotics:

Preservatives for inclusion with the present invention have little effect on alkalinity or do not require acidic conditions to be effective.

Probiotics for inclusion in compositions of the invention include, but are not limited to, Lactobacillus Acidophilus, Lactobacillus Plantarum, Bifidobacterium Bifidum, Bifidobacterium longum, Lactobacillus Bulgaricus, Lactobacillus Rhamnosus, Lactobacillus Paracasei, Lactobacillus Brevis and other like probiotics. Probiotics are included in levels to facilitate proper digestion and assimilation of foods. For example, probiotics have been shown to maintain the integrity of the intestinal wall and the intestinal environment. Probiotics have also been shown to control the levels of pathogenic bacteria in the gut and to neutralize toxins from being adsorbed into the body. It has also been shown that probiotic levels need to be replenished on a consistent basis.

For example, one liter of alkaline aqueous medium could contain approximately 10 billion Lactobacillus Acidophilus micro-organisms. Compositions of the invention can include one probiotic or mixtures of several probiotics. As described below, probiotics of the present invention are typically packaged separately from the alkaline based aqueous medium. A consumer of the beverage would take the packaged probiotic and add it to the composition at time of consumption to minimize the likelihood of the probiotic being inactivated due to processing and/or storage.

Flavoring Agents:

Flavoring agents of the invention include any agent that further enhances the taste profile for the compositions of the invention. Flavoring agents should have a minimal effect on the alkaline nature of the composition, unless the embodiment includes a buffering agent to minimize the effect of the agent on pH. Flavoring agents can include, but are not limited to, fruit flavors, botanical flavors, and sweet flavors. For example, ginseng, ginkgo, apple flavor, raspberry, peach, melon, ginger, cinnamon, chocolate, and the like are all envisioned as possible flavoring agents for purposes of the present invention. Preferred flavoring agents selection include flavors profiles that can be secured in an alkaline environment. Typical amounts of flavoring agents added to the alkaline aqueous medium embodiments of the present invention are adjusted to effectively enhance taste and are adjusted accordingly. In one example, 3 g of flavor are added to one liter of soluble fiber containing alkaline based aqueous medium.

Herbs and Botanicals:

Embodiments of the present invention can also include various amounts of herbs and/or botanicals. Herb and botanical ingredients include, but not limited to, alfalfa, ashwagandha, asparagus root, astragalus, bilberry extract, blueberry extract, black cohosh, boswellia, chamomile, ginseng, garcinia cambogia, bitter orange, polyphenols, proanthocyanadins/proanthocyanins, curcumin, damiana, dandelion root, grape seed extract, Echinacea, gou kola, white tea, green tea, oolong tea, black tea, wheat grass, barley grass, kamut grass, hawthorne, Ipimedium sagittatum (horny goat weed), maca, yohimbe, kava, kola nut, licorice, milk thistle, wolfberry extract and peppermint.

In a preferred embodiment, grape seed extract is added to the soluble fiber containing alkaline beverages of the invention. Grape seed extract has been shown to be a powerful antioxidant and a rich source of oligomeric proanthocyanidin complex (OPC) (known to prevent heart disease, stop tissue degeneration, improve blood circulation, and increase blood vessel strength). OPC has also been shown to protect and restore collagen. An effective amount of grape seed extract is included in embodiments of the present invention, for example from about 25 μg to about 200 μg/liter of beverage.

In another preferred embodiment, green tea is added to the soluble fiber containing alkaline beverages of the invention. Green tea is rich in polyphenols, including catechins that provide antioxidant protection, including scavenging of reactive oxygen species. In particular, green tea includes EGCG, an extremely powerful antioxidant, two hundred times more effective than vitamin E at neutralizing free radicals. In addition, Green tea has been shown to have beneficial effects on preventing cancer, atherosclerosis, inflammation, and infection. An effective amount of green tea is included in embodiments of the present invention, for example from about 20 μg to about 200 μg/liter of beverage.

In another preferred embodiment, bilberry extract is added to the soluble fiber containing alkaline beverages of the invention. Bilberry extract is believed to facilitate eye health, strengthening capillaries and veins and alleviate digestive issues. An effective amount of bilberry extract is included in embodiments of the present invention, for example from about 80 μg to about 500 μg/liter of beverage.

In another preferred embodiment, pycnogenol (pine bark extract) is added to the soluble fiber containing alkaline beverages of the invention. Pycnogenol is an antioxidant which can also bind collagen and maintain and restore skin elasticity. An effective amount of pycnogenol is included in embodiments of the present invention, for example from about 25 μg to about 100 μg/liter of beverage.

In another preferred embodiment, wolfberry extract (also known as Goji berry) is added to the soluble fiber containing alkaline beverages of the invention. Wolfberry extract has been shown to stimulate interleukin production, which enhances the activity of lymphocytes and other immune related reactions within the body. Wolfberry extract is useful in fighting bacterial infections. An effective amount of wolfberry extract is included in embodiments of the present invention.

Phospholipids:

Embodiments of the present invention can also include various amounts of phospholipids. Phospholipids of the invention include: lecithin, phosphatidylserine, and phosphatidylcholine. Phospholipids are a major constituent in cell membranes and have been shown to be a benefit in reducing heart disease.

Miscellaneous:

The American diet is enzyme deficient. Refined and processed food, as well as food preparation techniques, destroys the nutritional value of consuming various enzymes. Enzyme deficiency has been shown to contribute to unnecessary stress on body organs like the pancreas, liver and lymph system. Enzyme deficiency contributes to the acidification of the body and is believed to be involved in liver disease, high blood pressure, arteriosclerosis, tuberculosis, and obesity.

Embodiments of the present invention envision inclusion of various enzyme/protein additives into the soluble fiber containing alkaline beverages of the present invention. Various enzyme supplements have been shown to enhance digestion of food, repair tissue damage, and facilitate removal of toxins from the body.

Embodiments of the present invention are typically packaged as shelf-stable, i.e., stable at room temperature for about six months or longer, beverages that are for consumption with no additional manipulation, except for the optional addition of probiotics or enzymes etc.

In an alternative embodiment, the soluble fiber and other optional ingredients of the present invention can be formulated as “syrup” to which bottled alkaline water can be added.

Methods for Preparing Beverage Compositions of the Invention

In order to have shelf stable beverage compositions of the invention available in convenient and ready to drink formats, without the need for long term refrigeration, the beverages are often produced in commercial production. The commercial production method chosen must be compatible with the alkaline (reduced water) and fiber blends as well as the added nutrients and the type of container chosen.

Methods for preparing alkaline beverage compositions are provided in accordance with the present invention. Due to the alkalinity and ingredient composition of the present invention, several different methods can be used to prepare the beverages of the invention including both “hot fill” methods and “filtered” method. Determining which method to use in preparing compositions of the invention is partly determined by the facilities available, i.e., type of bottling plant, and partly by the composition ingredients.

As previously mentioned, the pH of a food/beverage at issue can provide assistance in the prevention of microbiological growth. Pathogenic bacteria normally do not proliferate at pH levels below 4.6 and are therefore of little concern under those acidic conditions. However, pathogenic organisms can proliferate at pH levels above 4.6 and can create situations harmful to human health. As such, embodiments of the invention must generally comply with established methods for low acid food production. In addition, if novel production methods are used in the production of low acid food production, they must be able to demonstrate reliability and consistency in the production of beverages safe from pathogenic activity.

Note that container selection may preclude some of the process options discussed below. For example, standard PET bottles cannot be used when a composition has been heated and is filled into the bottle at a temperature at or above about 130° F. Heat set PET bottles are required when the composition is filled into the bottle at a temperatures above 130° F.

In one embodiment, the water used in the commercial production of these inventive compositions will likely be reduced water prepared by ionic separation. In addition, since the beverages of the invention will not offer a microbiological barrier due to low pH (high acid environment), commercial processing options should be secure.

In one embodiment, compositions of the invention are processed in accordance with normal procedures for the aseptic production of low acid beverages (i.e. beverages with a pH greater than 4.6). This involves the use of ultra high temperature processing. This sterilization process is defined as a UHT (Ultra High Temperature) process if the product is heat-treated in a continuous flow at a temperature of not-less-than 135° C. (275° F.) for a very short time and aseptically packaged in sterile containers in a sterile environment at reduced temperatures. Probiotics, and other heat labile ingredients, are held out of the composition.

In another embodiment, assuming ingredients and containers contain no pathogenic organisms, compositions of the invention are “hot filled” into containers for use by the consumer. Probiotics, and other heat labile ingredients, are held out of the composition and the compositions of the invention pasteurized, i.e., the composition heated to 180° F.-205° F. for less than one minute to five minutes (the higher the temperature the shorter the time) pending desired processing profile.

Typically, the pasteurized composition is then dispensed at the increased temperature into appropriate containers (heat set PET bottles, aluminum cans, glass bottles, etc). Probiotics and other like heat labile materials are prepared separately to be added to the composition at time of consumption. This addition is ignored when no heat labile materials are to be consumed. Variations on this production method are envisioned to be within the scope of the present invention.

In an alternative embodiment, the composition can be combined and then filtered (typically a maximum pore size of 0.45 μm) before “hot filling” into sterile containers.

In an alternative embodiment, if process demands allow, compositions of the invention are filtered (typically a maximum pore size of 0.45 μm) into containers for use by the consumer without “hot filling”. Compositions of the invention are combined and maintained at room temperature, although the filtered compositions can be stored at cooled temperatures. Filtered compositions are dispensed and kept in sterile bottles.

Ingredients that are insoluble and have a size that prevents them passing through the filter are held out of the composition and are added separately after the filtration process, e.g., vitamin D. For example, compositions are filtered in the absence of probiotics, probiotics are then added to the compositions by the user at time of consumption. For example, probiotics can be packaged separately in a powdered form.

Non-filterable ingredients can also be directly injected into sterile compositions to minimize the potential for bioagent contamination.

In addition, preservatives can be added to the filtered compositions dependent on consumer preference and required shelf life. Preferred preservatives include those that can perform in an alkaline environment.

Compositions that have been either thermally processed and cooled or filtered can be treated with Velcorin®. A useful amount of Velcorin® is injected into the sterile compositions to increase the level of sanitation for the composition. Note that Velcorin® is an ingredient used often in the wine industry to ensure sanitation and reduce the level of bottled or constrained compositions of the invention from becoming contaminated with pathogenic and/or spoilage bacteria.

Finally, other new and novel processing methods including high pressure methodologies may be suitable for production of the composition.

Having generally described the invention, the same will be more readily understood by reference to the following example, which is provided by way of illustration and is not intended as limiting.

### EXAMPLES

Alkaline, Fiber Containing Beverage

The following example provides ingredients and preparation procedure for a soluble fiber containing alkaline beverage in accordance with the present invention. All Example beverages are fabricated using the methods of the invention and have a pH in the alkaline ranges of the invention described herein.

### Example 1

### Alkaline Beverage for Enhanced Bone Health

A natural alkaline solution that while offering the range of benefits of dietary fiber, is targeted at improving bone health. Fibers for inclusion in the beverage are all natural and include a blend of inulin, oligofructose and partially hydrolyzed guar gum.

Inulin—has been proven to improve uptake of calcium and magnesium and has relatively low caloric contribution. Inulin should not be the exclusive fiber in high dosage due to concern over gastric distress. Inulin can provide some mouthfeel to the beverage if required and is protected from hydrolization in the alkaline solution.

Oligofructose—has been proven to improve uptake of calcium and magnesium and has a low caloric contribution. Oligofructose should not be the exclusive fiber in high dosage due to concern over gastric distress. It is protected from hydrolization in the alkaline solution.

Partially hydrolyzed guar gum—has been shown to improve the uptake of minerals and is neutral tasting. It is natural and well tolerated so the total dietary fiber load can be increased over that which would be tolerated by inulin and oligofructose alone.

Complimentary nutrients such as bioavailable forms of calcium, magnesium, phosphorus and vitamin D would be added to the solution.

Natural flavoring agents (including natural sweeteners) may be added as well if desired. The product would be processed using thermal and/or physical methods.

### Example 2

### Alkaline Beverage for Enhanced Gastrointestinal Health

A lightly sweetened and natural alkaline solution focused on gastrointestinal health for consumers who don't wish or cannot consume dairy products. Fibers included in beverage are natural and include scFOS, oligofructose, partially hydrolyzed guar gum and arabinogalactan. This solution would be a “synbiotic” solution.

scFOS has been shown to be superior in terms of selective growth of beneficial digestive microorganisms through its ability as an “exclusive” food source. While more tolerated than inulin retains some concern with gastric distress in higher dosages. It is considered natural. It would be protected from hydrolization in the alkaline solution.

Partially hydrolyzed guar gum offers excellent food sources for beneficial bacteria and is well tolerated due to a slower fermentation rate. This gum has shown superior performance related to irritable bowel syndrome and diarrhea and is considered natural.

Oligofructose has been shown to offer excellent digestive benefits, is a food source for beneficial bacteria and has sweetening capabilities for the solution. While more tolerated than inulin retains some concern with gastric distress in higher dosages. It would be protected from hydrolization in the alkaline solution.

Arabinogalactan has been shown to have excellent prebiotic properties and is well tolerated. Not a choice as predominant fiber due to sensory concerns with “piney” taste.

Complimentary nutrients would primarily include a “dose” of beneficial bacteria such as Bifidobacterium or Lactobacillus via inclusion in the container closure and put in the beverage before consumption. Flavoring agents, including use of natural sweeteners, could also be included if desired.

### Example 3

### Alkaline Beverage for Glucose Buffering

A natural alkaline solution that provides benefit for persons suffering from diabetics and potential (type 2) diabetics by buffering the glucose response and simultaneously providing cardiovascular benefits. Fibers included in the beverage are arabinogalactan and partially hydrolyzed guar gum and digestive resistant maltodextrin.

Arabinogalactan has been shown to have excellent glucose response buffering capability and excellent cholesterol lowering effects in both hypercholesterolemics and healthy subjects. Single use in high dose may be a problem due to sensory concerns with taste. It is natural.

Partially hydrolyzed guar gum has been shown to have excellent glucose response buffering capability and excellent cholesterol lowering effects in healthy subjects and is well tolerated with neutral taste. It is natural.

Resistant maltodextrin has been shown to have excellent glucose response buffering capability and excellent cholesterol lowering effects in hypercholesterolemics.

Complimentary ingredients may include appropriate minerals such as selenium, and magnesium, vitamins such as vitamin E, B6, B12 & B9, herbs such as hawthorn, grape seed & pycnogenol and others such as L-carnitine, coenzyme Q10 and taurine etc. Flavoring agents may also be added.

### Example 4

### Alkaline Beverage for Assisting Digestion

An alkaline and low calorie solution that is not necessarily natural provides the benefits of soluble dietary fiber with a particular focus on assisting digestion and promoting regularity. Soluble fibers for combination in the beverage include polydextrose, arabinogalactan and partially hydrolyzed guar gum. This solution would be a “synbiotic” solution.

Polydextrose provides excellent benefits in fecal bulking and reduced transit time. It is well tolerated and has the lowest calorie contribution of the fibers.

Arabinogalactan provides excellent benefits in transit time and assists in providing well-formed stools. It has a lower calorie contribution than many fibers.

Partially hydrolyzed guar gum provides excellent benefits related to promoting regularity and reduced need for laxative agents while having positive results related to diarrhea.

Complimentary nutrients would primarily include a “dose” of beneficial digestive enzymes via inclusion in the container closure. Flavoring agents could also be included if desired.

All the beverages and methods disclosed herein can be made an executed without undue experimentation in light of the present disclosure. While the beverages and methods of this invention have been described in terms of preferred embodiments, it will be apparent to those of skill in the art that variations may be applied to the beverages and methods described herein without departing from the concept, spirit and scope of the invention.

All references herein, to the extent they provide exemplary procedural or other details supplementary to those set forth herein are specifically incorporated by reference herein.

What is claimed is:

1. A beverage comprising:
aqueous medium having a pH of at least 7.5; and
soluble fiber;
wherein the beverage is shelf stable and maintains a pH of at least 7.5.

2. The beverage of claim 1 further comprising one or more probiotic agents.

3. The beverage of claim 1 further comprising one or more nutrients.

4. The beverage of claim 1 further comprising flavoring agents.

5. The beverage of claim 1 wherein the aqueous medium has a pH of at least 8.5.

6. The beverage of claim 1 wherein the aqueous medium has a pH of at least 9.4.

7. The beverage of claim 1 wherein the soluble fiber is selected from the group consisting of inulin, oligofructose and scFOS.

8. The beverage of claim 1 wherein the soluble fiber is a mix of two or more soluble fibers wherein one of the soluble fibers is selected from the group consisting of inulin, FOS and scFOS.

9. The beverage of claim 1 wherein the soluble fiber is from about 1 gram per liter aqueous medium to about 60 grams per liter aqueous medium.

10. The beverage of claim 8 wherein the soluble fiber is from about 30 grams per liter aqueous medium to about 60 grams per liter aqueous medium.

11. A process for producing a commercially sterile alkaline beverage comprising:
combining an aqueous medium having a pH of at least 7.5 with an amount of soluble fiber; and
processing the soluble fiber containing aqueous medium to ensure a sterile composition;
wherein the filtered composition is shelf stable.

12. The process of claim 11 wherein the processing is thermal processing.

13. The process of claim 11 wherein the processing is filtering the soluble fiber containing aqueous medium through an at least 0.45 μm pore filter.

14. The process of claim 12 wherein the processing further includes addition of a sterilizing agent into the thermally processed composition.

15. The process of claim 13 wherein the processing further includes addition of a sterilizing agent into the filtered composition.

16. The process of claim 11 wherein the aqueous medium has a pH of at least 8.5.

17. The process of claim 11 wherein the aqueous medium has a pH of at least 9.4.

18. The process of claim 11 wherein the soluble fiber is selected from the group consisting of inulin, oligofructose and scFOS.

19. The process of claim 11 further comprising adding a probiotic agent to the processed soluble fiber containing aqueous medium.
